(19) United States
(12) Patent Application Publication
(10) Pub. No.: US 2014/0079898 A1
(43) Pub. Date: Mar. 20, 2014

(54) Polymer Articles Made From a Blend of a Copolyester Elastomer and an Alpha-Olefin Vinyl Acetate Copolymer

(71) Applicant: Ticona LLC, Florence, KY (US)

(72) Inventors: Mukul Kaushik, Florence, KY (US); Dirk Zierer, Hofheim (DE); Kenneth Leon Price, Florence, KY (US)

(73) Assignee: Ticona LLC, Florence, KY (US)

(21) Appl. No.: 14/030,736

(22) Filed: Sep. 18, 2013

Related U.S. Application Data
(60) Provisional application No. 61/849,821, filed on Mar. 7, 2013.
(60) Provisional application No. 61/702,399, filed on Sep. 18, 2012.

(51) Int. Cl. C08L 67/02; C09D 167/02

(52) U.S. Cl. CPC C08L 67/02; C09D 167/02
USPC 428/36.9; 525/176; 525/92 A; 524/352; 524/236; 524/359; 524/91; 428/375; 428/35.7; 428/430

(57) ABSTRACT

A polymer composition is disclosed that contains a thermoplastic elastomer combined with an α-olefin and vinyl acetate copolymer. In one embodiment, the composition contains a thermoplastic polyester elastomer combined with an ethylene and vinyl acetate copolymer. Various synergistic effects may be realized by combining the two polymers together. In particular, a resulting polymer mixture can be produced that has many of the properties of the thermoplastic elastomer and also has controlled melt flow properties. In addition, the polymer composition may have improved and controllable mechanical and thermal properties and color stability. The polymer composition may be processed using injection molding, blow molding, or extrusion and may undergo secondary processing. According to the present disclosure, the polymer composition and molded part may exhibit certain advantages such as a light weight, improved thermal and chemical stability, specific strength, elastic recovery, cold temperature impact strength, and fatigue and kink resistance.

### RELATED APPLICATIONS

This application claims filing benefit of U.S. Provisional Patent Application Ser. No. 61/702,399, filed on Sep. 18, 2012, and U.S. Provisional Patent Application Ser. No. 61/849,821, filed on Mar. 7, 2013, which are incorporated herein in their entirety.

### BACKGROUND

Thermoplastic elastomers are a class of useful materials that have a unique combination of properties. The materials, for instance, can be formulated so as to be flexible and tough, while having elastic characteristics. Of particular advantage, the materials can also be melt processed due to their thermoplastic nature. Furthermore, unlike their crosslinked rubber counterparts, thermoplastic elastomers can be recycled and reprocessed.

Thermoplastic elastomers are used in numerous applications. The materials, for instance, may be molded to form a particular part or product or may comprise a component in a product. In addition, these materials may also be overmolded allowing for an additional layer to be formed on an initially molded part. Due to their flexible and elastic nature, thermoplastic elastomers are commonly used in applications where the material constantly undergoes deformation or otherwise contacts other moving parts.

Although thermoplastic elastomers can be used in numerous applications, problems have been experienced in the past in processing the elastomers. For instance, some thermoplastic elastomers have relatively high viscosities and low melt strength that may present problems in some molding processes. In addition, some thermoplastic elastomers are not only expensive to produce, but also may darken or yellow in color over time. In addition, weathering may also affect the mechanical and thermal properties of the thermoplastic elastomers over time.

In view of the above, a need currently exists for a composition containing a thermoplastic elastomer that has controlled flow properties. In particular, a need exists for a method of improving and controlling the flow properties of a thermoplastic elastomer without adversely affecting other physical properties of the polymer. A need also exists for a method of improving the color of a thermoplastic elastomer as well as the weatherability of a thermoplastic elastomer. A need also exists for a composition that has the properties of a thermoplastic elastomer but can be produced at lower cost.

### SUMMARY

In general, the present disclosure is directed to polymer compositions containing a thermoplastic elastomer blended and/or compounded with an α-olefin and vinyl acetate copolymer. In accordance with the present disclosure, the two polymers are blended together. In one embodiment, the two polymers are blended together without reacting together. In an alternative embodiment, the two polymers are blended together with a crosslinking agent that may react with a component of the polymer composition. For instance, the crosslinking agent may react with at least one polymer.

In one embodiment, the α-olefin and vinyl acetate copolymer contains vinyl acetate units in an amount from about 3 weight % to about 50 weight %, such as from about 3 weight % to about 30 weight %, such as from about 3 weight % to about 20 weight %. The weight ratio between the thermoplastic polyester elastomer and the α-olefin and vinyl acetate copolymer can be from about 10:90 to about 90:10, such as from about 20:80 to about 80:20. In one embodiment, the weight ratio between the two polymers can be from about 25:75 to about 49:51 or from about 75:25 to about 51:49.

In one embodiment, the α-olefin and vinyl acetate copolymer comprises an ethylene vinyl acetate copolymer. The resulting polymer composition can have a melt flow rate at 220° C. and at 2.16 kg of greater than about 15 g/10 mins., such as greater than about 20 g/10 mins., such as even greater than about 25 g/10 mins. The resulting polymer composition can have a melt flow rate at 190° C. and at 2.16 kg of greater than about 0.1 g/10 mins., such as greater than about 1 g/10 mins., such as greater than about 2 g/10 mins. but less than about 12 g/10 mins., such as less than about 10 g/10 mins., such as less than about 8 g/10 mins., such as less than about 6 g/10 mins.

The thermoplastic elastomer may comprise a thermoplastic polyester elastomer, such as a multi-block copolyester elastomer. The thermoplastic polyester elastomer may contain soft segments and hard segments. The hard segments may comprise ester units, while the soft segments may comprise an aliphatic polyester or a polyester glycol. In one embodiment, the thermoplastic polyester elastomer has the following formula: −[4GT]x[BT]y, wherein 4G is 1,4-butane diol, B is poly(tetramethylene ether glycol) and T is terephthalate, and wherein x is about 0.6 to about 0.99 and y is about 0.01 to about 0.40.

The polymer composition may comprise an antioxidant. The antioxidant may comprise a sterically hindered phenol. The polymer composition may also comprise a light stabilizer. The light stabilizer may comprise a sterically hindered amine. The polymer composition may also comprise a UV absorber. The UV absorber may comprise a benzotriazole or benzophenone.

According to the present invention, the polymer composition may be processed using injection molding, blow molding, or extrusion. The polymer composition or molded part obtained therefrom may be secondarily processed using gluing, sealing, lamination, or welding.

The polymer composition of the present disclosure can be used to produce numerous articles. In one embodiment, the polymer composition may comprise a coating on a wire or may be used to produce a medical apparatus. In one embodiment, the polymer composition may comprise a glass overmolding for a window or windshield for an automobile.

Other features and aspects of the present disclosure are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a perspective view of one embodiment of a wire or cable made in accordance with the present disclosure;

FIG. 2 is a perspective view of a medical device made in accordance with the present disclosure;

FIG. 3A is a perspective view of tubes made in accordance with the present disclosure;

FIG. 3B is another perspective view of tubes made in accordance with the present disclosure;

FIG. 4 is a perspective view of a corrugated tube made in accordance with the present disclosure; and

FIG. 5 is a perspective view of a cover for a mobile phone made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polymer compositions that contain a thermoplastic elastomer combined with an α-olefin and vinyl acetate copolymer. Polymer compositions made according to the present disclosure are generally flexible and can have elastic properties. More particularly, the polymer compositions of the present disclosure can be formulated so as to have the physical properties of a thermoplastic elastomer while having improved and controlled flow properties. Adding the α-olefin and vinyl acetate copolymer to the thermoplastic elastomer may also, in some embodiments, improve the color of the thermoplastic elastomer.

In general, as described above, the polymer composition of the present disclosure contains a thermoplastic elastomer combined with an α-olefin and vinyl acetate copolymer. When combined together in accordance with the present disclosure, various synergistic effects occur. For instance, both polymers combine together to overcome some of the disadvantages of each individual polymer.

For instance, the presence of the α-olefin and vinyl acetate copolymer can dramatically improve the flow properties of the thermoplastic elastomer. Of particular advantage, the flow properties are improved, in one embodiment, without substantially and adversely impacting the physical properties of the thermoplastic elastomer. In addition, the presence of the α-olefin and vinyl acetate copolymer may also improve the melt strength of the thermoplastic elastomer. The melt strength may be improved as a result of a reduction in viscosity. Furthermore, the presence of the α-olefin and vinyl acetate copolymer may also allow for the ability to control the melt flow properties of the thermoplastic elastomer

The presence of the thermoplastic elastomer, on the other hand, greatly improves the ability of the α-olefin and vinyl acetate copolymer to be formed into different articles. For instance, α-olefin and vinyl acetate copolymers can have a relatively high cold flow and thus are rarely used in the form of moldings and extrusions. Instead, such polymers are typically used as an additive in emulsion paints, adhesives, and various textile finishing compositions. In addition, α-olefin and vinyl acetate copolymers have only been used in a limited basis for structural applications due to relatively weak mechanical properties. Furthermore, α-olefin and vinyl acetate copolymers, when used alone, generally exhibit a poor chemical resistance and thermal stability.

However, when combined with a thermoplastic elastomer in accordance with the present disclosure, the above disadvantages can be overcome even if the composition contains a substantial amount of the α-olefin and vinyl acetate copolymer. For instance, the composition may exhibit improved and controllable flow properties and melt strength. In addition, with the combination, the polymer composition may have a reduced density and improved viscosity. The polymer composition may also show improved adhesion characteristics on certain substrates such as plastics, metal, and/or glass.

Also of advantage is that compositions made according to the present disclosure can be tailored to achieve desired physical properties, such as flexural modulus. The ratio of the thermoplastic elastomer to the α-olefin and vinyl acetate copolymer, for instance, can be varied in order to produce articles having physical properties within narrow tolerance limits. The resulting polymer composition can also be formulated so as to have desired physical properties over a wide temperature range, especially compared to various other materials such as nitrile rubbers. The polymer composition may also exhibit a consistent performance over a wide temperature range.

Polymer compositions made in accordance with the present disclosure can be used in numerous and diverse applications. The polymer composition, for instance, can be used as a coating on a surface such as for refrigerators, garage doors, window panels, ceiling grids, and the like. Alternatively, various articles and products can be produced from the polymer composition. For example, since the polymer composition is thermoplastic in nature, the polymer composition can be molded into any suitable shape using, for instance, injection molding, blow molding, or extrusion. The polymer composition may be molded using overmolding or a soft-touch 2-shot overmolding process. In addition, the polymer composition and article produced therefrom may provide increased weldability for joint and heat sealing. Freestanding articles can be produced from the polymer composition or the polymer composition can form a coating or component on or in a product.

In one embodiment, for instance, the polymer composition may be used to produce coatings for wires. As used herein, a wire is referred to as any multi-layer article that has a linear configuration. The term wire, for instance, includes cables and all flexible threads or rods that include a core covered by a coating.

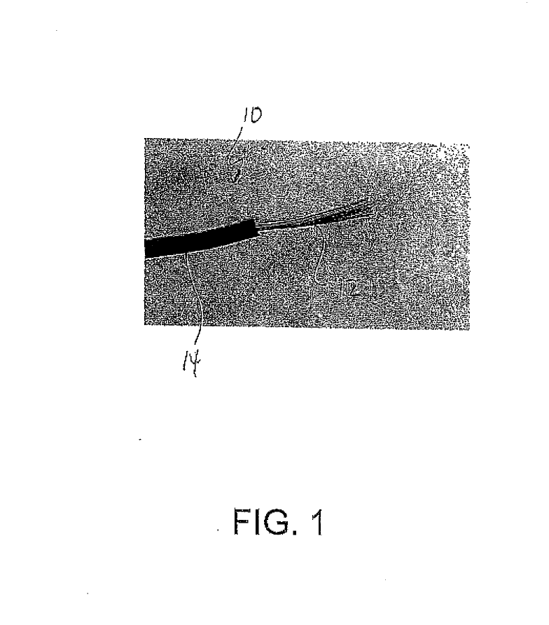

Referring to FIG. 1, for instance, one embodiment of a wire 10 in accordance with the present disclosure is shown. As illustrated, the wire 10 includes a core 12 that can be made from one or more metal elements. In the embodiment illustrated, for instance, the core 12 is made from multiple threads or filaments. The core 12 is surrounded by a coating or sheath 14 made in accordance with the present disclosure. In particular, the polymer composition containing the thermoplastic elastomer in combination with the α-olefin and vinyl acetate copolymer can be used to produce the sheath in forming the wire 10.

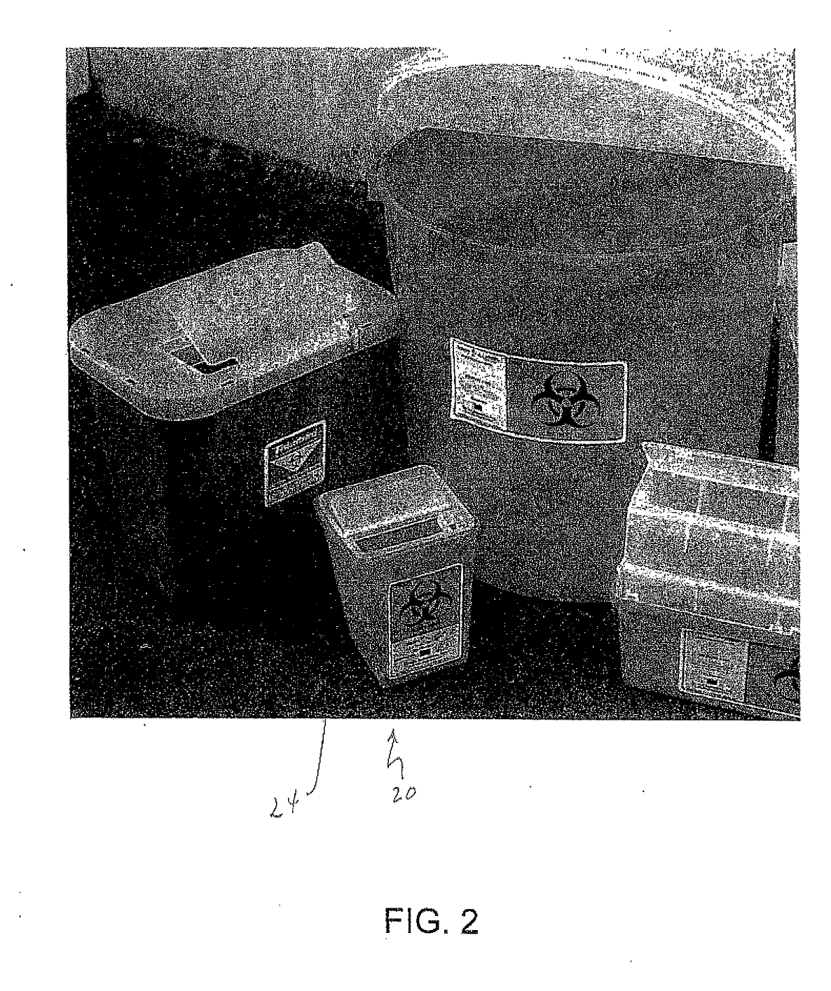

In an alternative embodiment, the polymer composition of the present disclosure can be used to produce a medical article. Of particular advantage, the polymer composition is non-reactive with body fluids, including blood. Thus, the composition is well suited to producing various different types of medical devices. In one embodiment, as shown in FIG. 2, the polymer composition can be used to produce a medical container, such as a container for medical waste. As shown in FIG. 2, a container 20 is illustrated that includes a top 22 attached to a bottom 24. The top 22 includes an opening 26 for receiving medical waste.

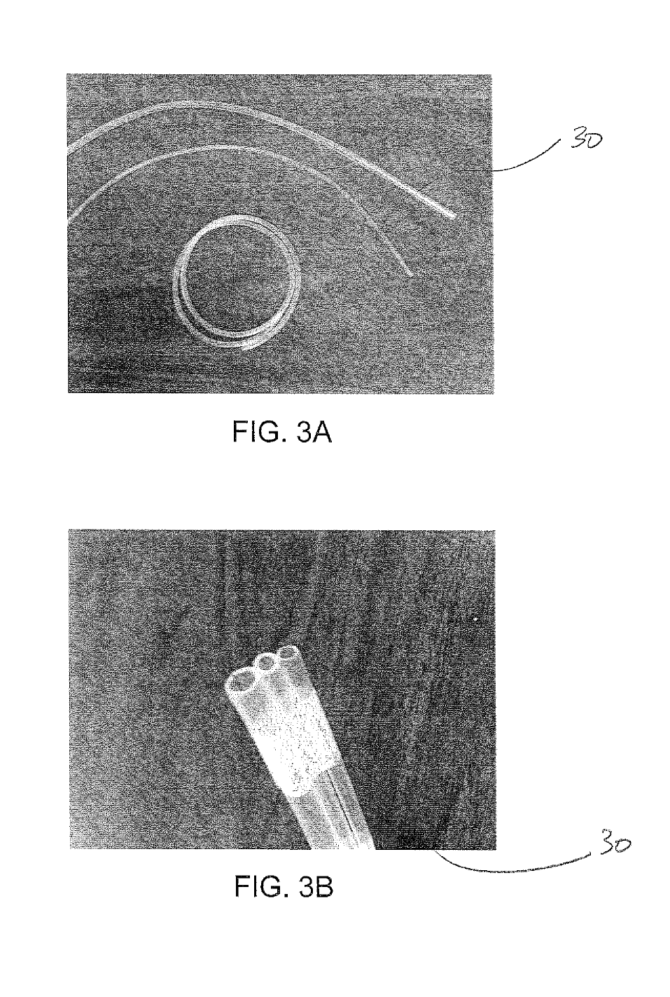

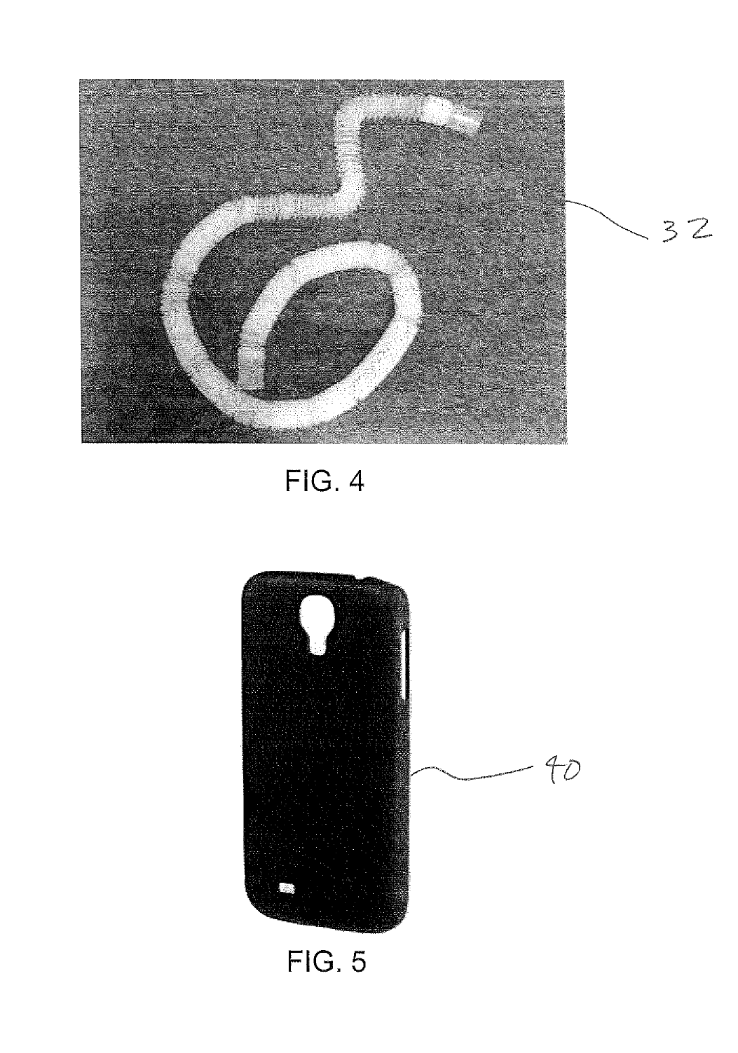

In an alternative embodiment, the polymer composition of the present disclosure can be used to produce other components for medical articles. As shown in FIGS. 3A, 3B, and 4, the polymer composition can also be used to produce tubing such as medical tubing. For instance, FIGS. 3A and 3B illustrate tubes 30. As shown in FIGS. 3A and 3B, the tubes are non-structured tubing. However, the composition of the present disclosure can also be used to produce structured tubing. As shown in the figures, the tubes may have different dimensions and wall thickness. These tubes may be used in applications such as for nutrition bags, blood bags, dialysis, urethral catheters, cardiovascular catheters, intravenous catheters, other specialty catheters and the Like. FIG. 4 illustrates a corrugated tube 32. These tubes may be used for anesthesia, ventilation, respiratory therapy, smoke evacuation, continuous positive airway pressure, colon hydrotherapy, breathing circuits and the like. While the majority of the applications listed above are directed to medical applications, it should be understood that the tubes can be used for other applications as well.

In an alternative embodiment, the polymer composition of the present disclosure can be used to produce protective covers and device handles for electronics. For instance, FIG. 5 illustrates a protective cover 40 for a mobile phone.

However, the polymer composition of the present disclosure can be used to produce a variety of different types of articles. The polymer composition can be used to produce films, molded articles, fibers, and the like. In particular, due at least to the biocompatibility of the polymers, the polymer composition may be used to produce packaging films and/or articles such as tubing for the food and medical industry. The medical tubing may comprise tubing for anesthesia, vitality signs, sleep apnea, catheters such as central venous catheters and urinary catheters, blood transportation and blood transfusion, dialysis, peristaltic, collection and drainage, and the like. Examples of central venous catheters include tunneled and non-tunneled catheters, peripherally inserted central catheters, implantable port catheters, and the like. The medical tubing can be used to convey blood, drugs, fluids and other therapies and/or materials to and from the body on a temporary or semi-permanent or permanent basis. The composition can be used to produce tubing and components for other apparatuses such as those for patient monitoring and diagnostic devices.

The composition can also be used to produce other components for the medical industry such as aspirators or prosthetic devices. The composition can also be used to produce medical films and sutures. The polymer composition can be used to produce breathable and/or waterproof laminates/films and/or fibers. These films/fibers can be used as biological barriers, adhesive dressings, fibers in elastic dressings, porous membranes for burn or ulcer management, tissues scaffolds, hydrogels, and the like.

The polymer composition can be used in transportation such as for shock absorption systems and for seating. In particular, the polymer composition can be used to produce glass overmolding such as for a window or windshield for an automobile. The polymer composition may also have an industrial application as a moving part such as gears and conveyor belts for food and material handling.

The polymer composition of the present disclosure may have other applications as well. For instance, the polymer composition can be used to produce bags, stretch-hooder films, specialty tie-layers, tubing, and the like. The polymer composition can be used to produce dampers and cushions, stoppers, caps and plugs, seals, grommets, gaskets, washers, gears, pulley and pulley components, valves, diaphragms, constant velocity joint boots, and the like. The polymer composition can be used to produce toys and toy component, ergonomic soft grips, device handles such as protective covers for electronics such as mobile phones and tablets, covers for cosmetic products such as compacts, and sporting goods and equipment. The polymer composition can be used to produce packaging materials such as those mentioned above as well as barrier films, household goods such as containers, furniture parts, and the like. The polymer composition can also be incorporated into moderate performance commodity articles, and the like.

In addition, the properties of the polymer composition and molded part or article produced therefrom may allow for secondary processing such as by joining two molded parts. The secondary processing techniques may include heat sealing, heat lamination, vibrating welding, ultrasonic welding, adhesive welding or adhesive gluing, or radio frequency welding. For instance, two injection molded parts may be welded together by secondary processing such as by heat sealing or radio frequency welding. Radio frequency welding can be conducted at room temperature due to a value of loss factor of more than about 0.55. In general, materials with a loss factor value of 0.3 or greater perform well for radio frequency welding. In general, materials with a loss factor of between about 0.2 and about 0.3 exhibit a good performance for radio frequency welding while a loss factor of between about 0.2 and 0.1 exhibits a fair to poor radio frequency welding. In addition, when the loss factor is high, a material may tend to heat more readily in an alternating radio frequency field. Therefore, in general, the higher the loss factor of a specific material, the more efficiently it may heat in an alternating radio frequency field.

In addition, two injection molded parts such as two hemispherical articles can be welded to produce a spherical object. Such spherical objects could be a bellow that provides a cushioning effect in athletic shoes, motorcycle boots, ski boots, and the like. The bellow may also be used to provide flexibility during movement such as for constant velocity joint boots or telemark ski-boots. As indicated above, the polymer composition of the present application may have a variety of applications.

The polymer composition of the present disclosure generally contains a thermoplastic elastomer combined with an α-olefin and vinyl acetate copolymer, such as an ethylene vinyl acetate copolymer. In general, the weight ratio between the thermoplastic elastomer and the α-olefin and vinyl acetate copolymer can range from about 10:90 to about 90:10, such as from about 20:80 to about 80:20, such as from about 25:75 to about 75:25, such as from about 35:65 to about 65:35. In one embodiment, the thermoplastic elastomer is present in the polymer composition in an amount greater than about 5 wt. % or in an amount less than about 5 wt. % in comparison to the amount of α-olefin and vinyl acetate copolymer present. For example, the stability of the polymer composition can be optimized when the two polymers are not present in about a 50 to about 50 weight ratio, such as in a weight ratio of from about 45:55 to about 55:45. In general, formulations of containing an ethylene vinyl acetate copolymer with elastomers and polymers are disclosed in U.S. Pat. No. 4,085,082 to Lamb et al., U.S. Pat. No. 4,243,576 to Fischer et al., and U.S. Pat. No. 4,403,007 to Coughlin, which are incorporated herein by reference.

In one embodiment, the thermoplastic elastomer may comprise a thermoplastic polyester elastomer. For example, the polymer composition may contain a copolyester elastomer such as a segmented thermoplastic copolyester. The thermoplastic polyester elastomer, for example, may comprise a multi-block copolymer. Useful segmented thermoplastic copolyester elastomers include a multiplicity of recurring long chain ester units and short chain ester units joined head to tail through ester linkages. The long chain units can be represented by the formula

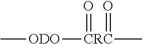

and the short chain units can be represented by the formula

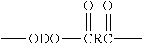

where G is a divalent radical remaining after the removal of the terminal hydroxyl groups from a long chain polymeric glycol having a number average molecular weight in the range from about 600 to 6,000 and a melting point below about 55° C., R is a hydrocarbon radical remaining after removal of the carboxyl groups from dicarboxylic acid having a molecular weight less than about 300, and D is a divalent radical remaining after removal of hydroxyl groups from low molecular weight diols having a molecular weight less than about 250.

The short chain ester units in the copolyetherester provide about 20 to 95% of the weight of the copolyetherester, and about 50 to 100% of the short chain ester units in the copolyetherester are identical.

The term “long chain ester units” refers to the reaction product of a long chain glycol with a dicarboxylic acid. The long chain glycols are polymeric glycols having terminal (or nearly terminal as possible) hydroxy groups, a molecular weight above about 600, such as from about 600-6000, a melting point less than about 55° C. and a carbon to oxygen ratio about 2.0 or greater. The long chain glycols are generally poly(alkylene oxide) glycols or glycol esters of poly(alkylene oxide) dicarboxylic acids. Any substituent groups can be present which do not interfere with polymerization of the compound with glycol(s) or dicarboxylic acid(s), as the case may be. The hydroxy functional groups of the long chain glycols which react to form the copolyesters can be terminal groups to the extent possible. The terminal hydroxy groups can be placed on end capping glycol units different from the chain, i.e., ethylene oxide end groups on poly(propylene oxide glycol).

The term “short chain ester units” refers to low molecular weight compounds or polymer chain units having molecular weights less than about 550. They are made by reacting a low molecular weight diol (below about 250) with a dicarboxylic acid.

The dicarboxylic acids may include the condensation polymerization equivalents of dicarboxylic acids, that is, their esters or ester-forming derivatives such as acid chlorides and anhydrides, or other derivatives which behave substantially like dicarboxylic acids in a polymerization reaction with a glycol.

The dicarboxylic acid monomers for the elastomer have a molecular weight less than about 300. They can be aromatic, aliphatic or cycloaliphatic. The dicarboxylic acids can contain any substituent groups or combination thereof which do not interfere with the polymerization reaction. Representative dicarboxylic acids include terephthalic and isophthalic acids, bibenzoic acid, substituted dicarboxy compounds with benzene nuclei such as bis(p-carboxyphenyl) methane, p-oxy-(p-carboxyphenyl) benzoic acid, ethylene-bis(p-oxybenzoic acid), 1,5-naphthalene dicarboxylic acid, 2,6-naphthalene dicarboxylic acid, 2,7-naphthalene dicarboxylic acid, phenanthralenedicarboxylic acid, anthralenedicarboxylic acid, 4,4′-sulfonyl dibenzoic acid, etc. and C₁-C₁₀ alkyl and other ring substitution derivatives thereof such as halo, alkoxy or aryl derivatives. Hydroxy acids such as p(β-hydroxyethoxy) benzoic acid can also be used providing an aromatic dicarboxylic acid is also present.

Representative aliphatic and cycloaliphatic acids are sebacic acid, 1,3- or 1,4-cyclohexane dicarboxylic acid, adipic acid, glutaric acid, succinic acid, carbonic acid, oxalic acid, itaconic acid, azelaic acid, diethylmalonic acid, fumaric acid, citraconic acid, allylmalonate acid, 4-cyclohexene-1,2-dicarboxylate acid, pimelic acid, suberic acid, 2,5-diethyladipic acid, 2-ethylsuberic acid, 2,2,3,3-tetramethylsuccinic acid, cyclopentanedicarboxylic acid, decahydro-1,5- (or 2,6-) naphthylenedicarboxylic acid, 4,4′-bicyclohexyl dicarboxylic acid, 4,4′-methylenebis(cyclohexyl carboxylic acid), 3,4-furan dicarboxylate, and 1,1-cyclobutane dicarboxylate.

The dicarboxylic acid may have a molecular weight less than about 300. In one embodiment, phenylene dicarboxylic acids are used such as terephthalic and isophthalic acid.

Included among the low molecular weight (less than about 250) diols which react to form short chain ester units of the copolyesters are acyclic, alicyclic and aromatic dihydroxy compounds. Included are diols with 2-15 carbon atoms such as ethylene, propylene, isobutylene, tetramethylene, pentamethylene, 2,2-dimethyltrimethylene, hexamethylene and decamethylene glycols, dihydroxy cyclohexane, cyclohexane dimethanol, resorcinol, hydroquinone, 1,5-dihydroxy naphthalene, etc. Also included are aliphatic diols containing 2-8 carbon atoms. Included among the bis-phenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol). Low molecular weight diols also include such equivalent ester-forming derivatives.

Long chain glycols which can be used in preparing the polymers include the poly(alkylene oxide) glycols such as polyethylene glycol, poly(1,2- and 1,3-propylene oxide) glycol, poly(tetramethylene oxide) glycol, poly(pentamethylene oxide) glycol, poly(hexamethylene oxide) glycol, poly(heptamethylene oxide) glycol, poly(octamethylene oxide) glycol, poly(nonamethylene oxide) glycol and poly(1,2-butylene oxide) glycol; random and block copolymers of ethylene oxide and 1,2-propylene oxide and poly-formals prepared by reacting formaldehyde with glycols, such as pentamethylene glycol, or mixtures of glycols, such as a mixture of tetramethylene and pentamethylene glycols.

In addition, the dicarboxymethyl acids of poly(alkylene oxides) such as the one derived from polytetramethylene oxide HOOCCH₂(OCH₂CH₂CH₂CH₂)ₓOCH₂COOH IV can be used to form long chain glycols in situ. Polythioether glycols and polyester glycols also provide useful products. In using polyester glycols, care must generally be exercised to control a tendency to interchange during melt polymerization, but certain sterically hindered polyesters, e.g., poly(2,2-dimethyl-1,3-propylene adipate), poly(2,2-dimethyl-1,3-propylene/2-methyl-2-ethyl-1,3-propylene 2,5-dimethylterephthalate), poly(2,2-dimethyl-1,3-propylene/2,2-diethyl-1,3-propylene, 1,4 cyclohexanedicarboxylate) and poly(1,2-cyclohexylenedimethylene/2,2-dimethyl-1,3-propylene 1,4-cyclohexanedicarboxylate) can be utilized under normal reaction conditions and other more reactive polyester glycols can be used if a short residence time is employed. Either polybutadiene or polyisoprene glycols, copolymers of these and saturated hydrogenation products of these materials are also satisfactory long chain polymeric glycols. In addition, the glycol esters of dicarboxylic acids formed by oxidation of polyisobutylenediene copolymers are useful raw materials.

Although the long chain dicarboxylic acids (IV) above can be added to the polymerization reaction mixture as acids, they react with the low molecular weight diols(s) present, these always being in excess, to form the corresponding poly(alkylene oxide) ester glycols which then polymerize to form the G units in the polymer chain, these particular G units having the structure

-DOCCH₂(OCH₂CH₂CH₂CH₂)ₓOCH₂COODO

when only one low molecular weight diol (corresponding to D) is employed. When more than one diol is used, there can be a different diol cap at each end of the polymer chain units. Such dicarboxylic acids may also react with long chain glycols if they are present, in which case a material is obtained having a formula the same as V above except the Ds are replaced with polymeric residues of the long chain glycols. The extent to which this reaction occurs is quite small, however, since the low molecular weight diol is present in considerable molar excess.

In place of a single low molecular weight diol, a mixture of such diols can be used. In place of a single long chain glycol or equivalent, a mixture of such compounds can be utilized, and in place of a single low molecular weight dicarboxylic acid or its equivalent, a mixture of two or more can be used in preparing the thermoplastic copolyester elastomers which can be employed in the compositions of this invention. Thus, the letter “G” in Formula II above can represent the residue of a single long chain glycol or the residue of several different glycols, the letter D in Formula III can represent the residue of one or several low molecular weight diols and the letter R in Formulas II and III can represent the residue of one or several dicarboxylic acids. When an aliphatic acid is used which contains a mixture of geometric isomers, such as the cis-trans isomers of cyclohexane dicarboxylic acid, the different isomers should be considered as different compounds forming different short chain ester units with the same diol in the copolyesters. The copolyester elastomer can be made by conventional ester interchange reaction.

As described above, the hardness of the thermoplastic elastomer can be varied by varying the amount of hard segments and soft segments. For instance, the thermoplastic elastomer can generally have a hardness of greater than about 10 Shore D, such as greater than about 15 Shore D, such as greater than about 20 Shore D. The hardness is generally less than about 70 Shore D, such as less than about 60 Shore D, such as less than about 55 Shore D, such as less than about 45 Shore D. In one embodiment, a thermoplastic polyester elastomer is used that has a Shore D hardness of from about 20 to about 45. In an alternative embodiment, a thermoplastic polyester elastomer is used that has a Shore D hardness of from about 22 to about 35. In an alternative embodiment, a thermoplastic elastomer may be used that has a Shore D hardness of from about 35 to about 47. And in another alternative embodiment, a thermoplastic elastomer may be used that has a Shore D hardness of from about 50 to about 70.

Copolyether esters with alternating, random-length sequences of either long chain or short chain oxyalkylene glycols can contain repeating high melting blocks that are capable of crystallization and substantially amorphous blocks with a relatively low glass transition temperature. In one embodiment, the hard segments can be composed of tetramethylene terephthalate units and the soft segments may be derived from aliphatic polyether and polyester glycols. Of particular advantage, the above materials resist deformation at surface temperatures because of the presence of a network of microcrystallites formed by partial crystallization of the hard segments. The ratio of hard to soft segments determines the characteristics of the material. Thus, another advantage to thermoplastic polyester elastomers is that soft elastomers and hard elastoplastics can be produced by changing the ratio of the hard and soft segments.

In one particular embodiment, the polyester thermoplastic elastomer has the following formula: −[4GT]ₓ[BT]_{y}, wherein 4G is butylene glycol, such as 1,4-butane diol, B is poly(tetramethylene ether glycol) and T is terephthalate, and wherein x is from about 0.60 to about 0.99 and y is from about 0.01 to about 0.40.

In general, the thermoplastic elastomer is present in the polymer composition in an amount of at least about 20% by weight, such as at least about 35% by weight, such as at least 45% by weight, such as at least 60% by weight but less than about 90% by weight, such as less than about 80% by weight, such as less than about 65% by weight, such as less than about 55% by weight. In one embodiment, the thermoplastic elastomer is present in the polymer composition in an amount from about 25% to about 45% by weight. In an alternative embodiment, the thermoplastic elastomer is present in the polymer composition in an amount from about 55% to about 80% by weight. Thus, the thermoplastic elastomer may comprise the major component or the minor component in the composition in comparison to the α-olefin and vinyl acetate copolymer.

The thermoplastic polyester elastomer may comprise a polyester polymer such as a polyalkylene terephthalate copolymer. The polyalkylene terephthalate copolymer may comprise a polyethylene terephthalate glycol-modified copolymer (PET-G) containing cyclohexane dimethanol or a polyethylene terephthalate glycol-modified copolymer containing neopentyl glycol, or a polyethylene terephthalate glycol-modified copolymer containing 2-methyl-1,3-propane diol. In one embodiment, for instance, the polyester used in the polymer composition comprises a glycol-modified polyethylene terephthalate in which the glycol is replaced with cyclohexane dimethanol or with neopentyl glycol. For instance, in one embodiment, at least about 5 mol percent, such as at least about 7 mol percent, such as at least about 10 mol percent, such as at least about 15 mol percent of the ethylene glycol may be modified. In general, the ethylene glycol may be modified by less than about 30 mol percent, such as less than about 25 mol percent, such as less than about 20 mol percent, such as less than about 15 mol percent. In certain embodiments, there may be advantages in using a polyester modified with neopentyl glycol, cyclohexane dimethanol, or with 2-methyl-1,3-propane diol because they may improve stress fracture resistance.

The polyester polymer may comprise a polyalkylene terephthalate copolymer, such as a polyethylene terephthalate acid-modified copolymer (PET-A) containing isophthalic acid or a polyethylene terephthalate acid-modified copolymer containing cyclohexane dicarboxylic acid. The polyester polymer may comprise a polyalkylene terephthalate copolymer, such as a polyethylene terephthalate glycol- and acid-modified copolymer containing cyclohexane dimethanol and isophthalic acid, or other combinations.

The thermoplastic elastomer is generally combined with a vinyl ester copolymer and particularly a vinyl ester of acetic acid copolymer. The copolymer contains vinyl ester monomeric units, such as vinyl acetate, in combination with other monomeric units. For instance, the other monomeric units may comprise an olefin, such as an α-olefin. In one embodiment, for instance, the α-olefin comprises ethylene.

The production of ethylene vinyl acetate copolymers can occur using various processes and techniques. In one embodiment, vinyl acetate is produced from light petroleum gases involving the oxidation of butane which yields various products, such as acetic acid and acetone. Two derivatives of these products are acetic anhydride and acetaldehyde. These two derivatives can react together to give ethylidene diacetate. Exposure of ethylidene diacetate to an aromatic sulphonic acid in the presence of excess acetic anhydride as a diluent yields significant amounts of vinyl acetate. For instance, the yield of vinyl acetate can be well over 30%, such as around 40%.

In recent years, vinyl acetate has been prepared in large quantities by the oxidation of ethylene. For example, if ethylene is passed into a solution containing a catalyst, such as palladium chloride, in a solution containing, for example, acetic acid and in the presence of sodium acetate, large quantities of vinyl acetate can be produced. The ethylene oxidation process can be carried out in either a liquid or vapor phase. The vapor phase, however, may provide various advantages because it can avoid problems with corrosion and the use of solvents.

A one-stage process for producing vinyl acetate directly from ethylene has also been proposed. In this process, ethylene is passed through a substantially anhydrous suspension or solution of acetic acid containing cupric chloride and copper or sodium acetate together with a palladium catalyst to yield vinyl acetate.

Vinyl acetate can then be polymerized in bulk, in solution, in an emulsion, or in a suspension. In the case of both polymer and monomer transfer, two mechanisms are possible that occur either at the tertiary carbon or at the acetate group. A radical formed at either of the tertiary carbon atom or at the acetate group can then initiate polymerization and form branched structures. In one embodiment, poly(vinyl acetate) is produced in an emulsion form during an emulsion polymerization process.

In one embodiment, approximately equal quantities of vinyl acetate and water are stirred together in the presence of a suitable colloid-emulsifier system, such as poly(vinyl alcohol) and sodium lauryl sulphate, and a water-soluble initiator such as potassium persulphate. Polymerization can take place over a period of time such as about four hours at relatively low temperatures, such as at temperatures less than about 100° C. The reaction is exothermic and thus, in some systems, cooling can occur during the process. In order to achieve better control of the process and to obtain particles with a small particle size, an initial portion of the monomer can first be polymerized while initiator is steadily added over a period of time. In some embodiments, the reaction occurs in the presence of a buffer, such as sodium acetate, in order to minimize hydrolysis of the vinyl acetate.

When producing an α-olefin and vinyl acetate copolymer, polymerization occurs with polyvinyl acetate in combination with another monomer, such as an ethylene source. Process conditions can be controlled so as to control the amount of vinyl acetate present in the resulting copolymer.

In this regard, the α-olefin and vinyl acetate copolymer used in the present disclosure generally contains greater amounts of the α-olefin in relation to the vinyl acetate. Vinyl acetate, for instance, is generally present in the copolymer in an amount less than about 50 weight %, such as less than about 40 weight %, such as less than about 30 weight %, such as less than about 28 weight %, such as less than about 20 weight %, such as less than about 18 weight %, such as less than about 15 weight %. The vinyl acetate is present in the copolymer generally in an amount greater than about 5 weight %, such as greater than about 7 weight %. Greater amounts of vinyl acetate in the resulting copolymer can, in some embodiments, lead to various disadvantages. For instance, the resulting polymer composition when combined with the thermoplastic elastomer may have an undesirable degree of tackiness and may also present processing problems. On the other hand, greater amounts of vinyl acetate may provide an increased resistance to environmental stress cracking as well as an increase in transparency.

According to the present disclosure, an α-olefin and vinyl acetate copolymer is combined with a thermoplastic elastomer. In general, as the amount of α-olefin and vinyl acetate copolymer content is increased, the polymer composition may exhibit an improvement in viscosity and melt strength. In general, an improvement in melt strength and an increase in viscosity may be obtained using a highly branched α-olefin and vinyl acetate copolymer. On the other hand, in general, an α-olefin and vinyl acetate copolymer with less branching may reduce the viscosity of the polymer composition.

As described above, the combination of an α-olefin and vinyl acetate copolymer and a thermoplastic elastomer in accordance with the present disclosure produces a polymer composition having excellent flow properties. For instance, compositions formulated in accordance with the present disclosure can have a melt flow rate of greater than about 15 g/10 mins., such as greater than about 20 g/10 mins., such as greater than about 25 g/10 mins., such as greater than about 30 g/10 mins. when measured at 220° C. and at 2.16 kg. The melt flow rate at the above conditions is generally less than about 60 g/10 mins., such as less than about 50 g/10 mins. (according to ISO Test 1133). The polymer composition can have a melt flow rate at 190° C. and at 2.16 kg of greater than about 0.1 g/10 mins., such as greater than about 1 g/10 mins., such as greater than about 2 g/10 mins but less than about 12 g/10 mins, such as less than about 10 g/10 mins., such as less than about 8 g/10 mins., such as less than about 6 g/10 mins.

As described above, the hardness of the polymer composition can be varied by varying the amount thermoplastic elastomer and α-olefin and vinyl acetate copolymer. For instance, hardness and other properties can be dependent upon the hardness of the thermoplastic elastomer, ratio of the thermoplastic elastomer to the α-olefin and vinyl acetate copolymer, hardness of the α-olefin and vinyl acetate copolymer, processing conditions, and presence of stabilizers and additives. For instance, the polymer composition can generally have a hardness of greater than about 10 Shore D, such as greater than about 15 Shore D, such as greater than about 20 Shore D. The hardness is generally less than about 70 Shore D, such as less than about 60 Shore D, such as less than about 55 Shore D, such as less than about 50 Shore D, such as less than about 48 Shore D. In one embodiment, the polymer composition has a Shore D hardness of from about 20 to about 35. In an alternative embodiment, the polymer composition has a Shore D hardness of from about 35 to about 47.

In general, the flexural modulus can vary widely depending upon the elastomer selected. In general, the flexural modulus can be from about 10 MPa to about 1,300 MPa when tested at 23° C., such as from about 10 MPa to about 400 MPa,

In addition to the above components, the polymer composition may include various other ingredients. For instance, the α-olefin and vinyl acetate copolymer may improve the color of the thermoplastic elastomer and therefore allow for the efficient use of colorants and/or dyes. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

In one embodiment, the polymer composition can also contain an acid scavenger. An acid scavenger may be used to combine with any acid, such as acetic acid, that may occur during processing or during use of the polymer composition. When present, the acid scavenger may prevent polymer degradation due to the evolution of an acid from the polymer. Examples of acid scavengers include the antioxidants described below.

Antioxidants that may be present in the composition include sterically hindered phenol compounds. The antioxidants may provide thermal stability during and after molding and/or any secondary processing. Examples of such compounds, which are available commercially, are pentaerythritol tetrakis[3-(3,5-di-tert-butyl-4-hydroxyphenyl)propionate] (Irganox 1010, BASF), triethylene glycol bis[3-(3-tert-butyl-4-hydroxy-5-methylphenyl)propionate] (Irganox 245, BASF), 3,3′-bis[3-(3,5-di-tert-butyl-4-hydroxyphenyl)propionohydrazide] (Irganox MD 1024, BASF), hexamethylene glycol bis[3-(3,5-di-tert-butyl-4-hydroxyphenyl)propionate] (Irganox 259, BASF), 3,5-di-tert-butyl-4-hydroxytoluene (Lowinox BHT, Chemtura) and n-octadecyl-β-(4-hydroxy-3,5-di-tert-butyl-phenyl)propionate. In one embodiment, for instance, the antioxidant comprises tetrakis[methylene(3,5-di-tert-butyl-4-hydroxyhydrocinnamate)]methane. The antioxidant may be present in the composition in an amount less than 2% by weight, such as in an amount from about 0.1 to about 1.5% by weight.

Light stabilizers that may be present in the composition include sterically hindered amines. Such compounds include 2,2,6,6-tetramethyl-4-piperidyl compounds, e.g., bis(2,2,6,6-tetramethyl-4-piperidyl) sebacate (Tinuvin 770, BASF) or the polymer of dimethyl succinate and 1-(2-hydroxyethyl)-4-hydroxy-2,2,6,6-tetramethyl-4-piperidine (Tinuvin 622, BASF). UV absorbers that may be present in the composition include benzophenones or benzotriazoles. Any suitable benzophenone or benzotriazole may be used in accordance with the present disclosure. The light stabilizer and UV absorber may improve weatherability and may be present in an amount from about 0.1% to about 3% by weight, such as from about 0.5% to about 1.5% by weight.

In one embodiment, the polymer composition may contain a blend of a light stabilizer and a UV absorber. The blend may also provide ultraviolet light resistance and color stability that prevents color fading. Furthermore, the blend may allow for the production of bright or fluorescent color products such as fluorescent ski boots. In one embodiment, the polymer composition may contain a combination of a benzotriazole or benzophenone UV absorber and a hindered amine light stabilizer such as an oligomeric hindered amine.

Fillers that may be included in the composition include glass beads, wollastonite, loam, molybdenum disulfide or graphite, inorganic or organic fibers such as glass fibers, carbon fibers or aramid fibers. The glass fibers, for instance, may have a length of greater than about 3 mm, such as from 5 to about 50 mm.

Various other stabilizers may also be present in the composition. For instance, in one embodiment, the composition may contain a phosphite, such as a diphosphite. For instance, in one embodiment, the phosphite compound may comprise a pentaerythritol phosphite, a pentaerythritol diphosphite, or a distearyl pentaerythritol diphosphite. The phosphite compound may also comprise bis(2,4-ditert-butylphenyl)pentaerythritol diphosphite. The phosphite compound may also comprise O,O′-Dioctadecylpentaerythritol bis(phosphite). An organophosphite processing stabilizer as described above may be present in the polymer composition in an amount less than about 2% by weight, such as in an amount from about 0.1% to about 1.5% by weight.

In one embodiment, the polymer composition may contain a crosslinking agent. The crosslinking agent may also serve as an impact modifier and/or as a reactive compatibilizer. The crosslinking agent may react with one or more components in the composition. For instance, the crosslinking agent may react with at least one polymer such as the thermoplastic elastomer. For instance, in general, crosslinking the thermoplastic elastomer may improve the melt strength and melt flow properties of the composition making the polymer composition more suitable for processing such as for blow molding or extrusion.

In one embodiment, the crosslinking agent may contain epoxy functionalization. For instance, any suitable epoxy resin that can form crosslinks may be used in the polymer composition. In one embodiment, the epoxy resin may be derived from bisphenol-A such as a poly(bisphenol A-co-epichlorohydrin) glycidyl end-capped resin. In one embodiment, the epoxy resin may be a cresol novolac epoxy resin derived from cresolformaldehyde novolac and epichlorohydrin. In general, the epoxy resin may be present in the polymer composition in an amount of less than about 3% by weight, such as less than about 1.5% by weight, such as less than about 1% by weight but greater than about 0.1% by weight.

In one embodiment, the crosslinking agent may include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers that may be utilized as the crosslinking agent include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate. In general, the epoxy-functional methacrylic monomer units may be present in the polymer composition in an amount of less than about 7.5% by weight, such as less than about 6% by weight but greater than about 0.1% by weight, such as greater than about 1% by weight, such as greater than about 2.5% by weight, such as greater than about 5% by weight.

In order to produce molded articles in accordance with the present disclosure, the different components of the polymer composition can be dry blended together in a drum tumbler or in a high intensity mixer. The premixed blends can then be melt blended and extruded as pellets. The pellets can then be used in an injection molding process, blow molding process, or extrusion process. The composition can also be process to form films such as cast films or blown films.

In one embodiment, for injection molding, the polymer composition may comprise an ethylene vinyl acetate random copolymer and a thermoplastic polyester elastomer. In one embodiment, for blow molding or extrusion, the polymer composition may comprise an ethylene vinyl acetate copolymer and a thermoplastic polyester elastomer such as a multiblock copolyester elastomer.

Molded articles can be produced by blending the different components and using a blow molding apparatus. In general, the polymer composition of the present disclosure exhibits good blow moldability. For instance, the polymer composition may generally show a good release from the die head with the ability to form a smooth surface. In addition, the molded article may also exhibit substantially uniform wall thickness distribution. In addition, the molded article may exhibit a good weld line with little or no notching.

According to the present disclosure, the polymer composition exhibits an improved and controlled melt strength for blow molding. In general, the polymer composition exhibits a complex viscosity of at least 4000 Pa·s at 190° C. and 0.1 rad/s during a dynamic rheology frequency sweep (ASTM D4440-08), such as at least 5000 Pa·s, such as at least 5500 Pa·s, such as at least 6000 Pa·s, such as at least 7000 Pa·s. In general, the complex viscosity at the above conditions is less than about 20000 Pa·s, such as less than about 15000 Pa·s, such as less than about 10000 Pa·s. In general, as the weight ratio between the thermoplastic polyester elastomer and α-olefin and vinyl acetate copolymer decreases, the complex viscosity may increase. In general, as the weight % of vinyl acetate units in the α-olefin and vinyl acetate copolymer increases, the complex viscosity may decrease.

The polymer composition of the present disclosure may also be extruded or blow molded to form a single layer or multilayer films. In general, the compositions of the present disclosure may produce good quality films. In addition, the films may not require an additional antiblocking agent. Without such additives, the films may be used as food grade packaging, medical packaging, or as a sacrificial layer during autoclaving of vacuum assisted resin transfer molding.

Articles, coatings, products and the like made in accordance with the present disclosure can have an excellent combination of physical properties. In fact, synergistic results can be shown when the thermoplastic elastomer is combined with the α-olefin and vinyl acetate copolymer. The resulting polymer composition, for instance, can have a combination of mechanical and thermal properties that are better than the components used to make the composition. Based on FTIR Spectra, in one embodiment, there appears to be no chemical reaction between the two polymers. Thus, the benefits received are from mechanical blending of the materials. In one embodiment, a crosslinking agent may be utilized in the composition that may react with a component of the polymer composition. Thus, the benefits may be received from a reaction between the crosslinking agent and one or more of the components of the polymer composition.

In general, the mechanical properties of the resulting polymer composition are dominated by the thermoplastic elastomer, while the α-olefin and vinyl acetate copolymer serves to improve and assist in controlling the flow properties of the composition and thus improving the processability. In addition, the α-olefin and vinyl acetate copolymer, in some embodiments, has a tendency to improve the appearance of the thermoplastic elastomer producing a composition that is brighter and lighter in color and somewhat translucent in comparison to the thermoplastic elastomer alone. Furthermore, the polymer composition of the present disclosure may have high fatigue resistance, kink resistance, chemical resistance, improved flex life, improved stability at high temperatures and low temperatures, improved melt strength and viscosity, improved abrasion resistance, and improved long term stability.

The present disclosure may be better understood with reference to the following examples.

### EXAMPLES

### Example 1

The following polymer compositions were formulated and dry blended together in a drum tumbler.

| | Control | Control | Control | Control | Sample | Sample | Sample | Sample | Sample |
|---|---|---|---|---|---|---|---|---|---|
| | No. 1 | No. 2 | No. 3 | No. 4 | No. 1 | No. 2 | No. 3 | No. 4 | No. 5 |
| | (wt. %) | (wt. %) | (wt. %) | (wt. %) | (wt. %) | (wt. %) | (wt. %) | (wt. %) | (wt. %) |
| Thermoplastic | | 100 | | | 50 | | | | 50 |
| polyester | | | | | | | | | |
| elastomer with 40 | | | | | | | | | |
| Shore D | | | | | | | | | |
| hardness | | | | | | | | | |
| Thermoplastic | | | 100 | | | 50 | | 50 | |
| polyester | | | | | | | | | |
| elastomer with 25 | | | | | | | | | |
| Shore D | | | | | | | | | |
| hardness | | | | | | | | | |
| Polybutylene | | | | 100 | | | 50 | | |
| terephthalate | | | | | | | | | |
| copolymer | | | | | | | | | |
| containing 30 | | | | | | | | | |
| mol % | | | | | | | | | |
| isophthalate units | | | | | | | | | |
| (30% of | | | | | | | | | |
| terephthalic acid | | | | | | | | | |
| was replaced with | | | | | | | | | |
| isophthalic acid) | | | | | | | | | |
| Tetrakis | | | | | 0.5 | 0.5 | 0.5 | 0.5 | 0.5 |
| [methylene (3,5- | | | | | | | | | |
| di-tert-butyl-4- | | | | | | | | | |
| hydroxy hydro | | | | | | | | | |
| cinnamate)] | | | | | | | | | |
| methane | | | | | | | | | |
| (antioxidant) | | | | | | | | | |
| Bis(2,4-ditert- | | | | | | 0.7 | 0.7 | 0.7 | 0.7 |
| butylphenyl) | | | | | | | | | |
| pentaerythritol | | | | | | | | | |
| diphosphite | | | | | | | | | |
| (stabilizer) | | | | | | | | | |
| n-octadecyl-β-(4- | | | | | 0.7 | | | | |
| hydroxy-3,5-di- | | | | | | | | | |
| tert-butyl-phenyl) | | | | | | | | | |
| propionate | | | | | | | | | |
| (antioxidant) | | | | | | | | | |
| Ethylene vinyl | 100 | | | | 48.8 | 48.8 | 48.8 | | |
| acetate | | | | | | | | | |
| copolymer | | | | | | | | | |
| containing 9 | | | | | | | | | |
| weight % vinyl | | | | | | | | | |
| acetate units | | | | | | | | | |
| Ethylene vinyl | | | | | | | | 48.8 | 48.8 |
| acetate | | | | | | | | | |
| copolymer | | | | | | | | | |
| containing 18 | | | | | | | | | |
| weight % vinyl | | | | | | | | | |
| acetate units | | | | | | | | | |

The premixed ingredients were melt-blended and extruded as pellets in a WLE-25 extruder having a SC-201 screw design under the following temperature settings:

| Barrel Zone | Temp. Setting (° C.) |
|---|---|
| 1 | 170-180 |
| 2 | 180-190 |
| 3 | 180-190 |
| 4 | 180-190 |
| 5 | 180-190 |
| 6 | 180-190 |
| Die head temp | 219 |
| Melt Temp | 180-190 |

The screw speed was set at, for example 250 RPM with 50% torque. A typical die vacuum was 15 mm of Hg and throughput was 40 lbs/hr.

Each of the formulations was conventionally injection molded after drying of pellets at 80° C. for 4 hr. to obtain a 0.02% moisture extent. Injection molded was conducted using a 4 oz. Demag 661 molding machine. The temperature settings were as follows:

| Zone | Temperature Setting (° C.) |
|---|---|
| Rear Barrel | 170-175 |
| Middle Barrel | 180-190 |
| Front Barrel | 180-190 |
| Nozzle | 180-190 |
| Melt | 180-190 |
| Moveable Mold | 20-40 |
| Stationary Mold | 20-40 |

The following results were obtained:

| | Control | Control | Control | Control | Sample | Sample | Sample | Sample | Sample |
|---|---|---|---|---|---|---|---|---|---|
| | No. 1 | No. 2 | No. 3 | No. 4 | No. 1 | No. 2 | No. 3 | No. 4 | No. 5 |
| Melt Flow | 2.8 | 10 | 13 | — | 33.82 | 7.69 | 7.39 | 6.01 | 6.87 |
| Rate | (190° C./ | (220° C./ | (190° C./ | | (220° C./ | (190° C./ | (190° C./ | (190° C./ | (220° C./ |
| (g/10 min) | 2.16 kg) | 2.16 kg) | 2.16 kg) | | 2.16 kg) | 2.16 kg) | 2.16 kg) | 2.16 kg) | 2.16 kg) |
| Flex | 101 | 85 | 17 | 392 | 72 | 55 | 835 | 75 | 121 |
| Modulus | (1% sec) | | | | | | | | |
| (23° C.) | | | | | | | | | |
| (MPa) | | | | | | | | | |
| Flex | — | — | 162 (−40) | 2009 | 341 | — | — | 414 | 426 |
| Modulus | | | | | | | | | |
| (−20° C.) | | | | | | | | | |
| (MPa) | | | | | | | | | |
| Tensile | — | 66 | — | 650 | 60 | 29 | 931 | 24 | 32 |
| Modulus | | | | | | | | | |
| (23° C.) | | | | | | | | | |
| (MPa) | | | | | | | | | |
| Tensile | 685 | — | 750 | 3.36 | 425 | 434 | 435 | 380 | 401 |
| Strain-yield | | | | | | | | | |
| (%) | | | | | | | | | |
| Tensile | 14 | — | 10 | 14.67 | 14 | 7.79 | 7.95 | 7.4 | 11.62 |
| Stress- | | | | | | | | | |
| yield (%) | | | | | | | | | |
| Notched | — | nb | nb | 77.9 | — | nb | 17.4 | nb | nb |
| Charpy | | | | | | | | | |
| (23° C.) | | | | | | | | | |
| (kJ/m²) | | | | | | | | | |
| Notched | — | — | nb | 3.3 | 93 | 57.7 | 3.4 | nb | nb |
| Charpy | | | | | | | | | |
| (−30° C.) | | | | | | | | | |
| (kJ/m²) | | | | | | | | | |
| Hardness- | 43 | 40 | 25 | — | 40.4 | 29.4 | 62.5 | 27.4 | 37.3 |
| Shore D | | | | | | | | | |

### Example 2

The following polymer compositions were formulated and dry blended together in a drum tumbler.

| | Sample | Sample | Sample | Sample | Sample | Sample | Sample | Sample | Sample | Sample |
|---|---|---|---|---|---|---|---|---|---|---|
| | No. 6 | No. 7 | No. 8 | No. 9 | No. 10 | No. 11 | No. 12 | No. 13 | No. 14 | No. 15 |
| | (wt. %) | (wt. %) | (wt. %) | (wt. %) | (wt. %) | (wt. %) | (wt. %) | (wt. %) | (wt. %) | (wt. %) |
| Thermoplastic | | | | | | | | | 50 | 50 |
| polyester | | | | | | | | | | |
| elastomer with | | | | | | | | | | |
| 40 Shore D | | | | | | | | | | |
| hardness | | | | | | | | | | |
| Thermoplastic | 75 | 50 | 25 | 25 | 50 | 75 | | 50 | | |
| polyester | | | | | | | | | | |
| elastomer with | | | | | | | | | | |
| 25 Shore D | | | | | | | | | | |
| hardness | | | | | | | | | | |
| Polyethylene | | | | | | | 50 | | | |
| terephthalate | | | | | | | | | | |
| copolymer | | | | | | | | | | |
| modified with | | | | | | | | | | |
| 12 mol % | | | | | | | | | | |
| neopentyl | | | | | | | | | | |
| glycol | | | | | | | | | | |
| Tetrakis | | | | | | | 0.5 | 0.5 | 0.5 | 0.5 |
| [methylene | | | | | | | | | | |
| (3,5-di-tert- | | | | | | | | | | |
| butyl-4- | | | | | | | | | | |
| hydroxyhydrocinnamate)] | | | | | | | | | | |
| methane | | | | | | | | | | |
| (antioxidant) | | | | | | | | | | |
| Bis(2,4-ditert- | | | | | | | 0.7 | 0.7 | 0.7 | 0.7 |
| butylphenyl) | | | | | | | | | | |
| pentaerythritol | | | | | | | | | | |
| diphosphite | | | | | | | | | | |
| (stabilizer) | | | | | | | | | | |
| Ethylene vinyl | 25 | 50 | 75 | | | | 48.8 | | | 48.8 |
| acetate | | | | | | | | | | |
| copolymer | | | | | | | | | | |
| containing 9 | | | | | | | | | | |
| weight % vinyl | | | | | | | | | | |
| acetate units | | | | | | | | | | |
| Ethylene vinyl | | | | | | | | | 48.8 | |
| acetate | | | | | | | | | | |
| copolymer | | | | | | | | | | |
| containing 18 | | | | | | | | | | |
| weight % vinyl | | | | | | | | | | |
| acetate units | | | | | | | | | | |
| Ethylene vinyl | | | | 75 | 50 | 25 | | 48.8 | | |
| acetate | | | | | | | | | | |
| copolymer | | | | | | | | | | |
| containing 28 | | | | | | | | | | |
| weight % vinyl | | | | | | | | | | |
| acetate units | | | | | | | | | | |

The premixed ingredients were melt-blended and extruded as pellets in a WLE-25 extruder having a SC-202 screw design under the following temperature settings:

| Barrel Zone | Temp. Setting (° C.) |
|---|---|
| 1 | 170-180 |
| 2 | 180-190 |
| 3 | 180-190 |
| 4 | 180-190 |
| 5 | 180-190 |
| 6 | 180-190 |
| Die head temp | 219 |
| Melt Temp | 180-190 |

The screw speed was set at, for example 250 RPM with 50% torque. A typical die vacuum was 15 mm of Hg and throughput was 50 lbs/hr.

Each of the formulations was conventionally injection molded after drying of pellets at 80° C. for 4 hr. to obtain a 0.02% moisture extent. Injection molded was conducted using a 4 oz. Demag 661 molding machine. The temperature settings were as follows:

| Zone | Temperature Setting (° C.) |
|---|---|
| Rear Barrel | 170-175 |
| Middle Barrel | 180-190 |
| Front Barrel | 180-190 |
| Nozzle | 180-190 |
| Melt | 180-190 |
| Moveable Mold | 20-40 |
| Stationary Mold | 20-40 |

The following results were obtained:

| | Sample | Sample | Sample | Sample | Sample | Sample | Sample | Sample | Sample | Sample |
|---|---|---|---|---|---|---|---|---|---|---|
| | No. 6 | No. 7 | No. 8 | No. 9 | No. 10 | No. 11 | No. 12 | No. 13 | No. 14 | No. 15 |
| Melt Flow | 10.83 | 6.97 | 3.92 | 4.58 | 7.28 | 10.74 | 2.49 | 7.51 | 7.96 | 10.03 |
| Rate | (190° C./ | (190° C./ | (190° C./ | (190° C./ | (190° C./ | (190° C./ | (190° C./ | (190° C./ | (220° C./ | (220° C./ |
| (g/10 min) | 2.16 kg) | 2.16 kg) | 2.16 kg) | 2.16 kg) | 2.16 kg) | 2.16 kg) | 2.16 kg) | 2.16 kg) | 2.16 kg) | 2.16 kg) |
| Flex Modulus | 27 | 44 | 65 | 19 | 21 | 17 | 628 | 27 | 51 | 70 |
| (23° C.) (MPa) | | | | | | | | | | |
| Flex Modulus | 128 | 275 | 604 | 127 | 72 | 80 | 1280 | 108 | 195 | 279 |
| (−20° C.) (MPa) | | | | | | | | | | |
| Tensile | 24 | 29 | 46 | 14 | — | — | 34 | 628 | 31 | 51 |
| Modulus | | | | | | | | | | |
| (23° C.) (MPa) | | | | | | | | | | |
| Tensile | 418 | 420 | 385 | 292 | 352 | 353 | 387 | 18.47 | 154 | 72.83 |
| Strain-yield | | | | | | | | | | |
| (%) | | | | | | | | | | |
| Tensile | 6.45 | 8.6 | 11.31 | 6.22 | 5.87 | 5.44 | 7.23 | 15.04 | 8.7 | 8.83 |
| Stress-yield | | | | | | | | | | |
| (%) | | | | | | | | | | |
| Notched | — | — | — | — | — | — | 10.0 | 0 | 0 | 37.2 |
| Charpy | | | | | | | | | | |
| (23° C.) | | | | | | | | | | |
| (kJ/m²) | | | | | | | | | | |
| Notched | 36.6 | 59.3 | 90.3 | 61.8 | 46 | — | 4 | 0 | 60 | 39.6 |
| Charpy | | | | | | | | | | |
| (−30° C.) | | | | | | | | | | |
| (kJ/m²) | | | | | | | | | | |
| Hardness- | 26 | 31.3 | 36.4 | 27 | 25 | 23.2 | 56.5 | 24.3 | 37 | 40.1 |
| Shore D | | | | | | | | | | |
| Vicat | — | — | — | — | — | — | 77.3 | 50.2 | 60.5 | 70.6 |
| Softening | | | | | | | | | | |
| Point (° C.) | | | | | | | | | | |
| Density | — | — | — | — | — | — | 1.065 | 1.007 | 1.0257 | 1.0214 |
| (g/cm³) | | | | | | | | | | |
| Tear strength | 68.6 | 62.4 | 62.5 | 56.6 | — | — | 91.6 | 55.6 | 92.5 | 96.5 |
| (kN/m) | | | | | | | | | | |

### Example 3

The following polymer compositions were formulated and dry blended together in a drum tumbler.

| | Control | Control | Sample | Sample |
|---|---|---|---|---|
| | No. 5 | No. 6 | No. 16 | No. 17 |
| | (wt. %) | (wt. %) | (wt. %) | (wt. %) |
| Thermoplastic polyester | | 100 | | 50 |
| elastomer with 40 Shore | | | | |
| D hardness | | | | |
| Thermoplastic polyester | 100 | | 50 | |
| elastomer with 25 Shore | | | | |
| D hardness | | | | |
| Ethylene vinyl acetate | | | | 50 |
| copolymer containing 12 | | | | |
| weight % vinyl acetate | | | | |
| units | | | | |
| Ethylene vinyl acetate | | | 50 | |
| copolymer containing 18 | | | | |
| weight % vinyl acetate | | | | |
| units | | | | |

Each of the formulations was conventionally blow molded for example using a Sterling accumulator head blowmolder with a 9 lb. head, a 3.5 inch diameter 24-1 UD extruder, and a single stage metering screw with 2.1:1 compression ratio and no mixing section. The lower die tooling was 4 inches in diameter resulting in a 9.5 inch layflat. The temperature settings were as follows:

| Zone | Temp. Setting (° C.) |
|---|---|
| 1 | 175-185 |
| 2 | 175-185 |
| 3 | 180-190 |
| Die Head | 187 |

The following results were obtained:

| | Control | Control | Sample | Sample |
|---|---|---|---|---|
| | No. 5 | No. 6 | No. 16 | No. 17 |
| Melt Flow Rate | 13 | 10 | 4.8 | 2.28 |
| (g/10 min) | (190° C./ | (220° C./ | (190° C./ | (190° C./ |
| | 2.16 kg) | 2.16 kg) | 2.16 kg) | 2.16 kg) |
| Flex Modulus (23° C.) | 17 | 85 | 31 | 62 |
| (MPa) | | | | |
| Flex Modulus (−20° C.) | 162 (−40) | 115 (−40) | 158 | 170 |
| (MPa) | | | | |
| Tensile Modulus (23° C.) | — | 75 | 19 | 43 |
| (MPa) | | | | |
| Tensile Strain-yield (%) | 750 | — | 366 | 424 |
| Tensile Stress-yield (%) | 10 | 17 | 7.95 | 12.55 |
| Notched Charpy | nb | nb | nb | nb |
| (23° C.) (kJ/m²) | | | | |
| Notched Charpy | nb | nb | 35.7 | nb |
| (−30° C.) (kJ/m²) | | | | |
| Hardness-Shore D | 25 | 40 | 27.8 | 36.6 |
| Vicat Softening Point | 61 | 119 | 54.4 | 76.1 |
| (° C.) | | | | |
| Density (g/cm³) | 1.06 | 1.15 | 0.9935 | 1.0311 |
| Tear Strength (kN/m) | 61 | 84 | 61.6 | 92.1 |

### Example 4

Dynamic rheology scans were conducted of the above formulations to determine the complex viscosity. The dynamic rheological test was performed on an ARESG2 (TA Instruments) equipped with 25 mm SS parallel plates. The gap distance was set to 1.0 mm. The frequency sweep was conducted at either 190° C. or 220° C.

The following results were obtained:

| Angular | Control No. 5 | Control No. 5 | Control No. 6 | Sample No. | Sample No. | Sample No. | Sample No. | Sample No. | Sample No. |
|---|---|---|---|---|---|---|---|---|---|
| Frequency | (190° C.) | (220° C.) | (220° C.) | 6 (190° C.) | 7 (190° C.) | 8 (190° C.) | 9 (190° C.) | 10 (190° C.) | 11 (190° C.) |
| (rad/s) | (Pa · s) | (Pa · s) | (Pa · s) | (Pa · s) | (Pa · s) | (Pa · s) | (Pa · s) | (Pa · s) | (Pa · s) |
| 500 | 341.374 | 225.695 | 319.661 | 297.925 | 251.985 | 203.793 | 243.362 | 288.895 | 310.526 |
| 315.479 | 400.598 | 255/42 | 376.634 | 356.671 | 311.789 | 259.101 | 308.298 | 357.377 | 370.801 |
| 199.054 | 453.326 | 279.75 | 428.711 | 415.033 | 375.929 | 323.384 | 382.785 | 425.708 | 429.538 |
| 125.594 | 497.662 | 299.627 | 474.744 | 474.995 | 447.669 | 399.613 | 471.269 | 507.351 | 488.913 |
| 79.2447 | 536.508 | 313.581 | 516.442 | 536.085 | 527.294 | 489.708 | 576.788 | 594.915 | 547.718 |
| 50 | 564.258 | 324.818 | 548.142 | 595.029 | 612.196 | 593.139 | 702.111 | 688.32 | 602.31 |
| 31.5479 | 586.479 | 332.547 | 574.781 | 656.627 | 707.747 | 718.09 | 846.727 | 784.64 | 657.582 |
| 19.9054 | 602.599 | 337.46 | 594.246 | 718.019 | 811.759 | 866.577 | 1021.53 | 889.624 | 710.005 |
| 12.5594 | 614.022 | 340.717 | 608.022 | 778.635 | 923.659 | 1043.99 | 1228.23 | 999.754 | 759.766 |
| 7.92447 | 621.852 | 342.587 | 616.995 | 837.728 | 1042.65 | 1257.1 | 1471.44 | 1114.43 | 806.135 |
| 5 | 626.121 | 343.157 | 622.272 | 893.633 | 1167.11 | 1511.3 | 1754.53 | 1230.65 | 847.864 |
| 3.15479 | 629.8 | 343.241 | 625.226 | 947.013 | 1295.32 | 1818 | 2085.61 | 1349.95 | 886.66 |
| 1.99054 | 631.649 | 343.791 | 626.888 | 996.663 | 1426.65 | 2182.99 | 2469.46 | 1468.85 | 920.201 |
| 1.25594 | 631.853 | 342.862 | 624.626 | 1041.84 | 1561.24 | 2620.37 | 2914.97 | 1586.14 | 950.404 |
| 0.792447 | 632.635 | 341.152 | 623.322 | 1084.5 | 1699.46 | 3147.37 | 3430.05 | 1704.4 | 976.66 |
| 0.5 | 628.739 | 339.948 | 619.71 | 1119.71 | 1837.46 | 3770.49 | 4020.34 | 1814.69 | 999.485 |
| 0.315479 | 626.189 | 341.152 | 609.742 | 1152.14 | 1980.13 | 4516.11 | 4679.08 | 1929.11 | 1022.35 |
| 0.199054 | 618.567 | 329.186 | 602.18 | 1175.27 | 2119.4 | 5390.04 | 5392.56 | 2041.84 | 1036.09 |
| 0.125594 | 620.203 | 327.976 | 590.295 | 1189.77 | 2255.45 | 6380.08 | 6109.62 | 2136.98 | 1044.73 |
| 0.1 | 607.765 | 329.25 | 579.079 | 1166.22 | 2310.76 | 6913.86 | 6427.99 | 2174.76 | 1026.75 |
| Angular | Sample No. | Sample No. | Sample No. | Sample No. | Sample No. | Sample No. | Sample No. | Sample No. | Sample No. |
| Frequency | 12 (190° C.) | 13 (190° C.) | 13 (220° C.) | 14 (220° C.) | 15 (220° C.) | 16 (190° C.) | 16 (220° C.) | 17 (190° C.) | 17 (220° C.) |
| (rad/s) | (Pa · s) | (Pa · s) | (Pa · s) | (Pa · s) | (Pa · s) | (Pa · s) | (Pa · s) | (Pa · s) | (Pa · s) |
| 500 | 409.122 | 274.024 | 216.037 | 230.544 | 199.821 | 320.35 | 241.378 | 333.38 | 238.492 |
| 315.479 | 539.749 | 338.253 | 259.977 | 287.5 | 247.318 | 402.993 | 295.902 | 428.754 | 300.485 |
| 199.054 | 695.797 | 406.158 | 306.447 | 349.816 | 300.294 | 494.716 | 354.501 | 540.942 | 371.811 |
| 125.594 | 885.502 | 480.787 | 355.936 | 420.713 | 358.741 | 599.285 | 420.021 | 676.973 | 456.903 |
| 79.2447 | 1112.65 | 561.732 | 408.421 | 500.41 | 424.449 | 717.793 | 492.548 | 841.447 | 557.85 |
| 50 | 1379.55 | 648.517 | 460.979 | 586.131 | 493.71 | 851.068 | 570.126 | 1038.82 | 672.969 |
| 31.5479 | 1685.95 | 737.115 | 517.78 | 683.28 | 571.254 | 996.227 | 658.37 | 1273.38 | 809.024 |
| 19.9054 | 2029.35 | 833.682 | 576.214 | 789.404 | 654.766 | 1164.53 | 756.6 | 1541.82 | 964.171 |
| 12.5594 | 2393.02 | 936.014 | 636.312 | 904.046 | 744.576 | 1356.84 | 866.288 | 1860.29 | 1138.07 |
| 7.92447 | 2793.3 | 1043.78 | 697.742 | 1027.65 | 840.502 | 1577.99 | 989.834 | 2225.95 | 1328.92 |
| 5 | 3210.88 | 1155.85 | 758.951 | 1158.07 | 940.959 | 1831.67 | 1127.2 | 2635.07 | 1533.79 |
| 3.15479 | 3646.23 | 1273.8 | 820.259 | 1296.71 | 1050.08 | 2126.65 | 1281.38 | 3088.69 | 1751.37 |
| 1.99054 | 4091.22 | 1395.02 | 880.176 | 1441.27 | 1161.45 | 2468.41 | 1454 | 3582.34 | 1977.71 |
| 1.25594 | 4543.88 | 1516.91 | 935.525 | 1592.45 | 1278.41 | 2858.56 | 1642.87 | 4099.32 | 2201.77 |
| 0.792447 | 5005.99 | 1645.22 | 987.961 | 1750.27 | 1398.35 | 3314.9 | 1851.62 | 4647.48 | 2434.27 |
| 0.5 | 5474.73 | 1775.88 | 1036.18 | 1906.33 | 1519.5 | 3843.04 | 2077.02 | 5213.37 | 2663.32 |
| 0.315479 | 5958.74 | 1909.89 | 1080.14 | 2064.01 | 1639.83 | 4468.8 | 2327.32 | 5803.22 | 2890.45 |
| 0.199054 | 6481.9 | 2052.27 | 1113.92 | 2217.6 | 1760.48 | 5227.26 | 2607.06 | 6420.14 | 3123.21 |
| 0.125594 | 7091.63 | 2189.59 | 1157.3 | 2358.61 | 1870.83 | 6129.95 | 2863.94 | 7074 | 3341.87 |
| 0.1 | 7410.34 | 2252.82 | 1174.64 | 2422.39 | 1900.56 | 6731.3 | 2941.72 | 7445.13 | 3395.57 |

As shown above, the viscosity and melt strength can be adjusted by varying the components in the formulations as well as the amounts of each component.

### Example 5

The following polymer compositions were formulated and dry blended together in a drum tumbler.

| | Sample | Sample | Sample | Sample | Sample |
|---|---|---|---|---|---|
| | No. 18 | No. 19 | No. 20 | No. 21 | No. 22 |
| | (wt. %) | (wt. %) | (wt. %) | (wt. %) | (wt. %) |
| Thermoplastic polyester elastomer with 40 | 57.5 | 53 | 57.5 | | |
| Shore D hardness | | | | | |
| Thermoplastic polyester elastomer with 25 | | | | 50 | 50 |
| Shore D hardness | | | | | |
| Pentaerythritol tetrakis[3-(3,5-di-tert-butyl-4- | 0.5 | 0.5 | 0.5 | | |
| hydroxyphenyl)propionate] (antioxidant) | | | | | |
| Ethylene vinyl acetate copolymer containing 9 | 32.8 | 32.8 | 32.8 | | |
| weight % vinyl acetate units | | | | | |
| Ethylene vinyl acetate copolymer containing 16 | | | | 50 | |
| weight % vinyl acetate units | | | | | |
| Ethylene vinyl acetate copolymer containing 18 | 8 | 8 | 8 | | |
| weight % vinyl acetate units | | | | | |
| Ethylene vinyl acetate copolymer containing 28 | | | | | 50 |
| weight % vinyl acetate units | | | | | |
| O,O′-Dioctadecylpentaerythritol bis(phosphite) | 0.7 | 0.7 | 0.7 | | |
| (stabilizer) | | | | | |
| Poly(bisphenol A-co-epichlorohydrin) glycidyl | 0.5 | | | | |
| end-capped (crosslinking agent) | | | | | |
| Ethylene and glycidyl methacrylate copolymer (8 | | 5 | | | |
| wt. % glycidyl methacrylate) (crosslinking agent) | | | | | |
| Cresol novalac epoxy resin derived from | | | 0.5 | | |
| cresolformaldehyde novolac and epichlorohydrin | | | | | |
| (epoxy resin) (crosslinking agent) | | | | | |

The premixed ingredients were melt-blended and extruded as pellets in a WLE-25 extruder having a SC-202 screw design under the following temperature settings:

| Barrel Zone | Temp. Setting (° C.) |
|---|---|
| 1 | 170-180 |
| 2 | 180-190 |
| 3 | 180-190 |
| 4 | 180-190 |
| 5 | 180-190 |
| 6 | 180-190 |
| Die head temp | 219 |
| Melt Temp | 180-190 |

The screw speed was set at, for example 250 RPM with 50% torque. A typical die vacuum was 15 mm of Hg and throughput was 50 lbs/hr.

Each of the formulations was conventionally injection molded after drying of pellets at 80° C. for 4 hr. to obtain a 0.02% moisture extent. Injection molded was conducted using a 4 oz. Demag 661 molding machine. The temperature settings were as follows:

| Zone | Temperature Setting (° C.) |
|---|---|
| Rear Barrel | 170-175 |
| Middle Barrel | 180-190 |
| Front Barrel | 180-190 |
| Nozzle | 180-190 |
| Melt | 180-190 |
| Moveable Mold | 20-40 |
| Stationary Mold | 20-40 |

The following results were obtained:

| | Sample | Sample | Sample | Sample | Sample |
|---|---|---|---|---|---|
| | No. 18 | No. 19 | No. 20 | No. 21 | No. 22 |
| Flex Modulus (23° C.) | 67 | 68 | 65 | 33 | — |
| (MPa) | | | | | |
| Flex Modulus (−20° C.) | 211 | 234 | 227 | — | — |
| (MPa) | | | | | |
| Tensile Modulus (23° C.) | 38 | 41 | 43 | 27 | — |
| (MPa) | | | | | |
| Notched Charpy (23° C.) | nb | nb | nb | nb | nb |
| (kJ/m²) | | | | | |
| Notched Charpy (−30° | 62.8 | 56.3 | 74.3 | 67 | nb |
| C.) (kJ/m²) | | | | | |
| Hardness-Shore D | 37 | 37.3 | 36.4 | 28.3 | 22.3 |
| Vicat Softening Point | 100.3 | 96.4 | 89.7 | 49.1 | 42.7 |
| (° C.) | | | | | |
| Density (g/cm³) | 1.033 | 1.02 | 1.03 | 0.987 | 0.993 |
| Tear Strength (kN/m) | 74.4 | 77.1 | 74.1 | — | — |

In the above tables, melt flow rate was determined according to ISO Test 1133. Flexural modulus was determined according to ISO Test 178, while the tensile tests were measured according to ISO Test 527. ISO Test 179 was used to determine notched Charpy results. ISO Test 34 was used to determine tear strength. ISO Test 306 was used to determine the Vicat Softening point temperature. ASTM D4440-08 was used to determine the dynamic rheology properties.

As shown above, combining an α-olefin and vinyl acetate copolymer with a thermoplastic elastomer can produce polymer compositions having excellent melt flow rates but also with various properties depending upon the desired result. Thus, as stated above, polymer compositions made according to the present disclosure can be used in numerous applications.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A polymer composition comprising:
a thermoplastic polyester elastomer; and
an α-olefin and vinyl acetate copolymer, the α-olefin and vinyl acetate copolymer containing vinyl acetate in an amount from about 3 weight % to about 50 weight %, the weight ratio between the thermoplastic polyester elastomer and the α-olefin and vinyl acetate copolymer being from about 20:80 to about 80:20.

2. A polymer composition as defined in claim 1, wherein the α-olefin and vinyl acetate copolymer comprises an ethylene vinyl acetate copolymer.

3. A polymer composition as defined in claim 1, wherein the weight ratio between the thermoplastic polyester elastomer and the α-olefin and vinyl acetate copolymer is from about 20:80 to about 45:55.

4. A polymer composition as defined in claim 1, wherein the weight ratio between the thermoplastic polyester elastomer and the α-olefin and vinyl acetate copolymer is from about 80:20 to about 55:45.

5. A polymer composition as defined in claim 1, wherein the polymer composition has a melt flow rate at 220° C. and at 2.16 kg of greater than about 15 g/10 mins.

6. A polymer composition as defined in claim 1, wherein the polymer composition has a melt flow rate at 220° C. and at 2.16 kg of greater than about 20 g/10 mins.

7. A polymer composition as defined in claim 1, wherein the polymer composition has a melt flow rate at 220° C. and at 2.16 kg of greater than about 25 g/10 mins. to about 40 g/10 mins.

8. A polymer composition as defined in claim 1, wherein the polymer composition has a melt flow rate at 190° C. and at 2.16 kg of from about 0.1 g/10 mins. to about 8 g/10 mins.

9. A polymer composition as defined in claim 1, wherein the polymer composition has a complex viscosity at 190° C. and an angular frequency of 0.1 rad/s of greater than about 5000 Pa·s.

10. A molded article made from the polymer composition defined in claim 1.

11. A molded article as defined in claim 10, wherein the molded article is produced from blow molding.

12. A cable or wire comprising a coating made from the polymer composition defined in claim 1.

13. A mobile phone cover made from the polymer composition defined in claim 1.

14. A medical tube made from the polymer composition defined in claim 1.

15. A polymer composition as defined in claim 4, wherein the α-olefin and vinyl acetate copolymer comprises an ethylene vinyl acetate copolymer, the copolymer containing vinyl acetate in an amount from about 3 weight % to about 50 weight %, the composition having a melt flow rate at 220° C. and at 2.16 kg of greater than about 15 g/10 mins.

16. A polymer composition as defined in claim 1, wherein the α-olefin and vinyl acetate copolymer containing vinyl acetate in an amount from about 3 weight % to about 30 weight %.

17. A polymer composition as defined in claim 1, wherein the polymer composition has a flexural modulus of from about 10 to about 400 MPa at 23° C.

18. A polymer composition as defined in claim 1, wherein the thermoplastic polyester elastomer contains soft segments and hard segments.

19. A polymer composition as defined in claim 18, wherein the thermoplastic polyester elastomer comprises a multi-block copolyester elastomer.

20. A polymer composition as defined in claim 18, wherein the hard segments comprise ester units and the soft segments comprise an aliphatic polyester or a polyester glycol.

21. A polymer composition as defined in claim 1, wherein the thermoplastic polyester elastomer has the following formula: −[4GT]x[BT]y, wherein 4G is 1,4-butane diol, B is poly(tetramethylene ether glycol) and T is terephthalate, and wherein x is about 0.6 to about 0.99 and y is about 0.01 to about 0.40.

22. A polymer composition as defined in claim 1, wherein the thermoplastic polyester elastomer is modified with neopentyl glycol, cyclohexane dimethanol, or 2-methyl-1,3-propane diol.

23. A polymer composition as defined in claim 1, wherein the composition further comprises a crosslinking agent comprising an epoxy functional group.

24. A polymer composition as defined in claim 1, wherein the composition further comprises an antioxidant comprising a sterically hindered phenol.

25. A polymer composition as defined in claim 1, wherein the composition further comprises a light stabilizer comprising a sterically hindered amine.

26. A polymer composition as defined in claim 1, wherein the composition further comprises a UV absorber comprising a benzophenone or a benzotriazole.

27. A polymer article comprising a molded member made from a polymer composition comprising:
a thermoplastic polyester elastomer; and
an α-olefin and vinyl acetate copolymer, the α-olefin and vinyl acetate copolymer containing vinyl acetate in an amount from about 3 weight % to about 50 weight %, the weight ratio between the thermoplastic polyester elastomer and the α-olefin and vinyl acetate copolymer being from about 20:80 to about 80:20.

28. A molded polymer article as defined in claim 27, wherein the polymer article comprises a medical apparatus.

29. A molded polymer article as defined in claim 28, wherein the medical apparatus is a medical tube.

30. A molded polymer article as defined in claim 27, wherein the polymer article comprises a glass overmolding.

31. A molded polymer article as defined in claim 27, wherein the polymer article is produced from blow molding.

32. A molded polymer article as defined in claim 27, wherein the polymer article comprises a mobile phone cover.
